(19) United States
(12) Patent Application Publication
(10) Pub. No.: US 2008/0024035 A1
(43) Pub. Date: Jan. 31, 2008

(54) Power system

(75) Inventors: Metin Aydin, Istanbul (TR); Mustafa K. Guven, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/495,483

(22) Filed: Jul. 31, 2006

(51) Int. Cl. H02K 47/00; H02K 16/02; H02P 5/00; H02K 21/12

(52) U.S. Cl. 310/268; 318/139; 310/114; 310/112; 310/156.32

(57) ABSTRACT

A power system includes an axial-flux motor/generator. The axial-flux motor/generator may include a housing, a first rotor supported at least partially from the housing, and a second rotor supported at least partially from the housing. The second rotor may be mechanically decoupled from the first rotor. The power system may also include a mechanical power source drivingly connected to the first rotor. Additionally, the power system may include power-system controls. The power-system controls may be operable to selectively cause the mechanical power source to drive the first rotor while the axial-flux motor/generator generates electricity with mechanical power the first rotor receives from the mechanical power source. The power-system controls may also be operable to selectively cause the axial-flux motor/generator to operate as an electric motor to rotate the second rotor. Additionally, the power-system controls may be operable to control torque on the first rotor and torque on the second rotor independently.

### TECHNICAL FIELD

The present disclosure relates to power systems and, more particularly, to power systems that include one or more axial-flux motor/generators.

### BACKGROUND

Many power systems include an axial-flux motor/generator drivingly connected to one or more other components. For example, many mobile machines have a power system that includes an axial-flux motor/generator drivingly connected to propulsion devices, such as wheels. In order to propel the mobile machine, the power system may supply electricity to the axial-flux motor/generator in a manner to cause the axial-flux motor/generator to operate as an electric motor to drive the propulsion devices. Such a power system may use various devices to supply electricity to the axial-flux motor/generator to propel the mobile machine. In some cases, batteries supply electricity to the axial-flux motor/generator. Unfortunately, batteries may only be capable of supplying enough electricity to propel the mobile machine for a relatively short period.

U.S. Pat. No. 5,214,358 to Marshall (“the '358 patent”) shows a motor vehicle that includes an electric motor drivingly connected to road wheels and an alternator drivingly connected to an internal combustion engine. The internal combustion engine drives the alternator and generates electricity. Using electricity generated by the alternator, the electric motor of the '358 patent drives the wheels, thereby propelling the motor vehicle.

Although the motor vehicle shown by the '358 patent includes an internal combustion engine and an alternator that supply electricity to an electric motor to propel the motor vehicle, certain disadvantages persist. For example, a separate electric motor and alternator may occupy an undesirably large amount of space that could otherwise be used for other components. Additionally, including a separate electric motor and alternator may undesirably increase the component costs of the motor vehicle.

The power system and methods of the present disclosure solve one or more of the problems set forth above.

### SUMMARY OF THE INVENTION

One disclosed embodiment relates to a power system that includes an axial-flux motor/generator. The axial-flux motor/generator may include a housing, a first rotor supported at least partially from the housing, and a second rotor supported at least partially from the housing. The second rotor may be mechanically decoupled from the first rotor. The power system may also include a mechanical power source drivingly connected to the first rotor. Additionally, the power system may include power-system controls. The power-system controls may be operable to selectively cause the mechanical power source to drive the first rotor while the axial-flux motor/generator generates electricity with mechanical power the first rotor receives from the mechanical power source. The power-system controls may also be operable to selectively cause the axial-flux motor/generator to operate as an electric motor to rotate the second rotor. Additionally, the power-system controls may be operable to control torque on the first rotor and torque on the second rotor independently.

Another embodiment relates to a method of operating a power system. The method may include supporting a first rotor of an axial-flux motor/generator at least partially from a housing of the axial-flux motor/generator. The method may also include supporting a second rotor of the axial-flux motor/generator at least partially from the housing, and the second rotor may be mechanically decoupled from the first rotor. The method may also include selectively supplying electricity to a first electrical coil of the axial-flux motor/generator in a manner to operate the axial-flux motor/generator as an electric motor driving the first rotor. Additionally, the method may include selectively driving the second rotor with a mechanical power source while using the axial-flux motor/generator to generate electricity with mechanical power the second rotor receives from the mechanical power source.

A further embodiment relates to a mobile machine that includes one or more propulsion devices and a power system. The power system may include a mechanical power source and an axial-flux motor/generator. The axial-flux motor/generator may include a housing. The axial-flux motor/generator may also include a first rotor supported at least partially from the housing, and the first rotor may be drivingly connected to the mechanical power source. Additionally, the axial-flux motor/generator may include a second rotor supported at least partially from the housing, and the second rotor may be mechanically decoupled from the first rotor and drivingly connected to one or more of the one or more propulsion devices. The axial-flux motor/generator may also include a stator disposed adjacent at least one of the first rotor and the second rotor.

### BRIEF DESCRIPTION OF THE DRAWINGS

FIG. 1 is a diagrammatic illustration of one embodiment of a power system according to the present disclosure;

FIG. 2 is a close-up view of one embodiment of an axial-flux motor/generator according to the present disclosure; and

FIG. 3 is a close-up view of another embodiment of an axial-flux motor/generator according to the present disclosure.

### DETAILED DESCRIPTION

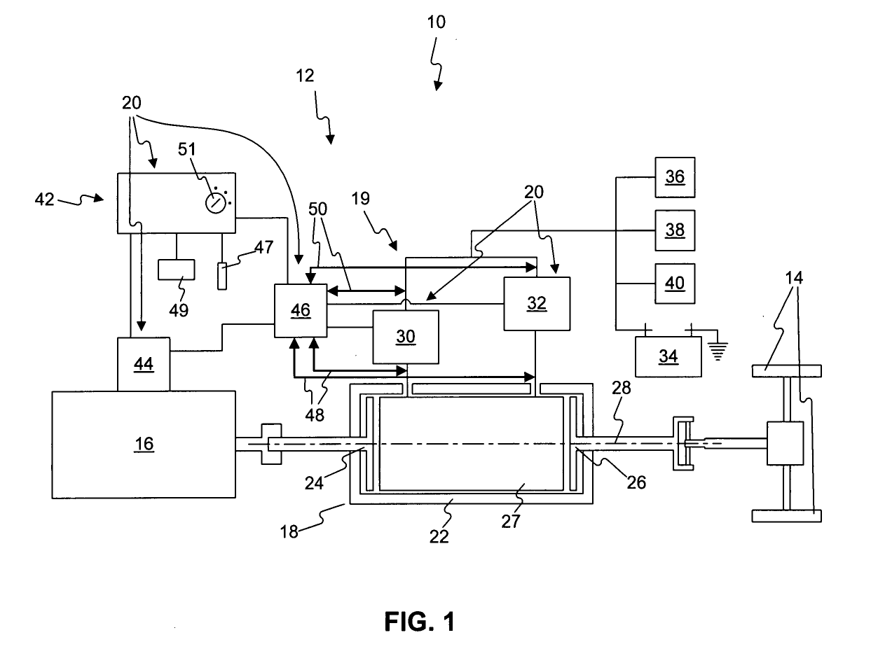

FIG. 1 illustrates a machine 10 including a power system 12 according to the present disclosure. Machine 10 may be a mobile machine having one or more propulsion devices 14 connected to power system 12. Power system 12 may include a mechanical power source 16, an electrical power-transfer network 19, one or more electrical power sources and/or loads, power-system controls 20, and an axial-flux motor generator 18 (also commonly known by various other names, such as axial-airgap motor/generator, axial-gap motor/generator, and disc motor/generator). Mechanical power source 16 may be any type of device configured to produce mechanical power, including, but not limited to, a diesel engine, a gasoline engine, a gaseous fuel driven engine, and a gas turbine engine.

Axial-flux motor/generator 18 may include a housing 22, a rotor 24, and a rotor 26. Rotors 24, 26 may each be supported from housing 22 in a manner allowing each rotor 24, 26 to rotate about a common axis 28. Housing 22 may support rotors 24, 26 directly and/or one or more components supported by housing 22, such as bearings, may support rotors 24, 26. Rotors 24, 26 may be mechanically decoupled from one another. Rotor 24 may be drivingly connected to mechanical power source 16, and rotor 26 may be drivingly connected to propulsion devices 14.

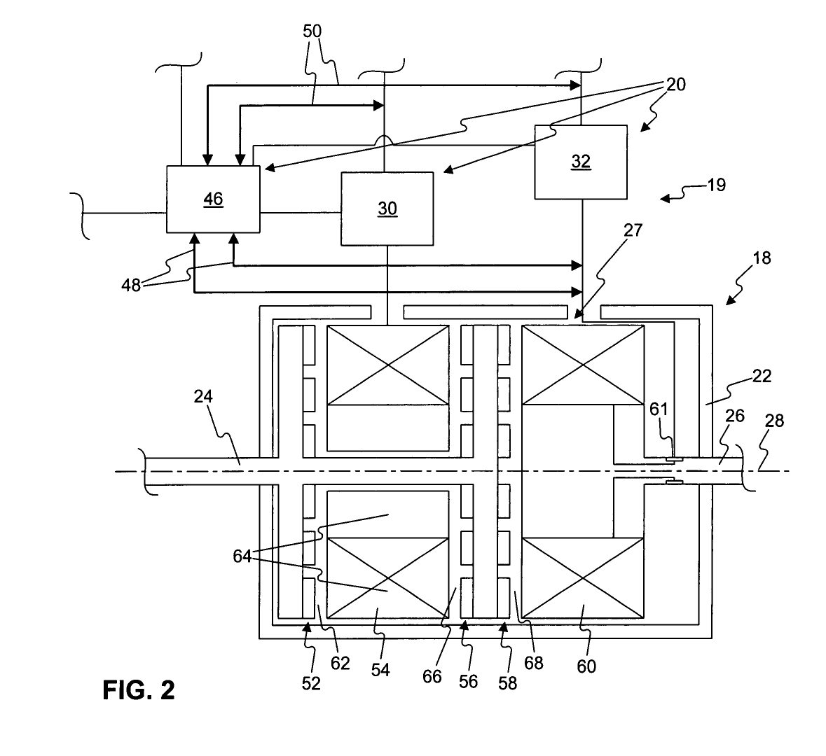

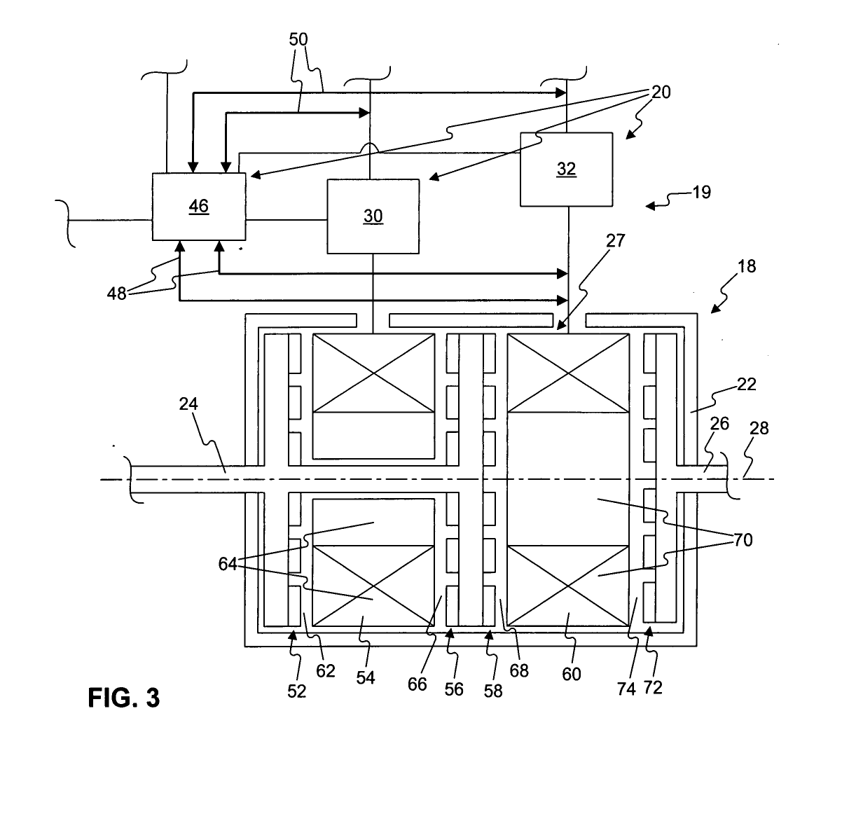

Axial-flux motor/generator 18 may also include a power-conversion system 27 configured to convert between mechanical power at rotors 24, 26 and electrical power in electrical power-transfer network 19. Power-conversion system 27 may include various sources of magnetic flux, such as electrical coils (not shown in FIG. 1) and/or permanent magnets (not shown in FIG. 1). Power-conversion system 27 may include one or more rotating components and/or one or more stationary components. Some of the electrical coils and/or permanent magnets of power-conversion system 27 may be disposed on rotor 24 and/or rotor 26, and some of the electrical coils and/or permanent magnets of power-conversion system 27 may be disposed proximate rotors 24, 26. One or more electrical coils of power-conversion system 27 may connect to electrical power-transfer network 19 so that they may receive electricity therefrom and/or supply electricity thereto. Two exemplary embodiments of power-conversion system 27 are discussed in greater detail hereinbelow in connection with FIGS. 2 and 3. In some embodiments, including those shown in FIGS. 1-3, housing 22 of axial-flux motor/generator 18 may house only components related to causing axial-flux motor/generator 18 to generate electricity or to operate as an electric motor.

Electrical power-transfer network 19 may electrically connect power-conversion system 27 and various other electrical components of power system 12. Electrical power-transfer network 19 may include a power regulator 30, a power regulator 32, and various electrical conductors connecting power regulators 30, 32 to power-conversion system 27 and various other electrical components. Power regulators 30, 32 may be configured to regulate one or more aspects of the operation of axial-flux motor/generator 18 by regulating electrical activity in one or more components of power-conversion system 27. This may include regulating various timing aspects of electrical activity, such as the phase and/or frequency of alternating current, in one or more components of power-conversion system 27. Power regulators 30, 32 may also be configured to regulate power transfer between different components of power-conversion system 27 and/or to regulate power transfer between power-conversion system 27 and other electrical components of power system 12. Additionally, one or both of power regulators 30, 32 may be configured to convert power between different forms, such as alternating current and direct current, as the power flows between power-conversion system 27 and other electrical components.

Electrical power sources and/or loads connected to electrical power-transfer network 19 may include a battery 34, accessories 36, 38, 40, an operator interface 42, and controllers 44, 46. Accessories 36, 38, 40 may include devices such as lights, windshield wipers, power windows, power seats, radios, blowers, heaters, and/or various other types of electrical components for facilitating operation of machine 10.

Power-system controls 20 may include power regulator 30, power regulator 32, operator interface 42, controller 44, and controller 46. Operator interface 42 may include any types of components configured to transmit operator inputs to other components of machine 10. For example, operator interface 42 may include an accelerator pedal 47 and various associated components for receiving acceleration requests from an operator and transmitting such acceleration requests to other components of machine 10. Similarly, operator interface 42 may include a brake pedal 49 and various associated components for receiving braking requests from an operator and transmitting such braking requests to other components of machine 10. Additionally, operator interface 42 may include a starter switch 51 and various associated components for receiving from an operator a request to start mechanical power source 16 and transmitting that request to other components of machine 10.

Each controller 44, 46 may be any type of device configured to control one or more aspects of the operation of machine 10. Each controller 44, 46 may include one or more processors (not shown) and one or more memory devices (not shown). Controller 44 may be operatively connected to mechanical power source 16, operator interface 42, controller 46, and various other sources of information (not shown). Controller 44 may control one or more aspects of the operation of mechanical power source 16 dependent upon inputs from operator interface 42, controller 46, and other sources of information. Controller 46 may be operatively connected to power regulators 30, 32, operator interface 42, and controller 44. Additionally, information channels 48 may supply controller 46 with information regarding the state of electrification in components of power-conversion system 27. Similarly, information channels 50 may supply controller 46 with information relating to the state of electrification in electrical power-transfer network 19. Based on information received from operator interface 42, controller 44, information channels 48, information channels 50, and/or various other sources of information, controller 46 may control power regulators 30, 32 to control one or more aspects of the operation of axial-flux motor/generator 18.

Propulsion devices 14 may be any type of device configured to receive power from power system 12 and propel machine 10 by applying that power to the environment surrounding machine 10. For example, as FIG. 1 shows, propulsion devices 14 may be wheels. Alternatively, propulsion devices 14 may be track units, other types of devices configured to transmit power to the ground, propellers, or other types of devices configured to move fluid to propel machine 10.

Machine 10 is not limited to the configuration shown in FIG. 1. For example, while FIG. 1 shows a common axis of rotation 28 for both rotors 24, 26, rotors 24, 26 may have separate axes of rotation. Additionally, mechanical power source 16, axial-flux motor/generator 18, and propulsion devices 14 may be connected in different manners. Whereas FIG. 1 shows mechanical power source 16 directly connected to rotor 24, power system 12 may include various power-transfer components connected between mechanical power source 16 and rotor 24, such as shafts, gears, clutches, belts and pulleys, sprockets and chains, and/or fluid couplers. Power system 12 may include similar components connected between rotor 26 and propulsion devices 14. Additionally, power system 12 may include various provisions for selectively decoupling rotor 24 from mechanical power source 16 and/or selectively decoupling rotor 26 from propulsion devices 14.

Additionally, power-system controls 20 may include other controllers in addition to controllers 44, 46. Alternatively, power-system controls 20 may replace controllers 44, 46 with a single controller that controls mechanical power source 16 and power regulators 30, 32. In some embodiments, power-system controls 20 may replace controllers 44, 46 with hard-wired control circuits or other similar control components.

FIG. 2 provides a close-up view of axial-flux motor/generator 18, showing the details of one embodiment of power-conversion system 27 thereof. In the embodiment shown in FIG. 2, power-conversion system 27 has five sources of magnetic flux, including a plurality of permanent magnets 52, an electrical coil 54, a plurality of permanent magnets 56, a plurality of permanent magnets 58, and an electrical coil 60. Electrical coil 54 may be part of a stator 64, and electrical coil 54 may be electrically connected to power regulator 30. Plurality of permanent magnets 52 may be mounted to rotor 24 with an axial interface 62 disposed between plurality of permanent magnets 52 and electrical coil 54. As used herein, the term “axial interface” refers to an interface whereat a portion of a rotor 24, 26 facing generally in the direction of its axis 28 of rotation faces a portion of an adjacent component that faces generally in the opposite direction. Plurality of permanent magnets 52 may have magnetic poles facing generally toward axial interface 62 so that plurality of permanent magnets 52 transmits magnetic flux across axial interface 62 to electrical coil 54. Similarly, electrical coil 54 may be configured in a manner such that supplying it with electricity causes electrical coil 54 to generate magnetic flux that flows across axial interface 62 to plurality of permanent magnets 52. Electrical coil 54 may be any various types of electrical coils that may function in this manner, including, but not limited to, a slot-wound electrical coil and a Gramme-type electrical coil.

Plurality of permanent magnets 56 may be disposed adjacent a side of electrical coil 54 opposite plurality of permanent magnets 52. Plurality of permanent magnets 56 may be attached to rotor 24 with an axial interface 66 disposed between plurality of permanent magnets 56 and electrical coil 54. Plurality of permanent magnets 56 may have magnetic poles facing generally toward axial interface 66 so that plurality of permanent magnets 56 transmits axial flux across axial interface 66 to electrical coil 54. Additionally, electrical coil 54 may be configured in a manner such that supplying electrical coil 54 with electricity causes electrical coil 54 to generate magnetic flux that flows across axial interface 66 to plurality of permanent magnets 56.

Plurality of permanent magnets 58 and electrical coil 60 may electromagnetically couple rotor 24 and rotor 26. Plurality of permanent magnets 58 may be mounted to rotor 24. Electrical coil 60 may be mounted to rotor 26 with an axial interface 68 disposed between plurality of permanent magnets 58 and electrical coil 60. Plurality of permanent magnets 58 may have magnetic poles facing generally toward axial interface 68 so that plurality of permanent magnets 58 may transmit magnetic flux across axial interface 68. Additionally, electrical coil 60 may be configured such that supplying electricity to electrical coil 60 causes electrical coil 60 to generate magnetic flux that flows across axial interface 68 to plurality of permanent magnets 58. Electrical coil 60 may be any of various types of electrical coils that may function in this manner, including, but not limited to, a slot-wound electrical coil and a Gramme-type electrical coil. Electrical coil 60 may electrically connect to power regulator 32 through brushes 61 that contact rotor 26.

Paired sources of magnetic flux may have equal numbers of magnetic poles. For example, plurality of permanent magnets 52 and electrical coil 54 may have equal numbers of poles. Similarly, plurality of permanent magnets 56 may have the same number of poles as electrical coil 54. Additionally, plurality of permanent magnets 58 and electrical coil 60 may have equal numbers of poles.

In some embodiments, the sources of magnetic flux associated with rotor 24 may have a different number of magnetic poles than the sources of magnetic flux associated with rotor 26. For example, in some embodiments, plurality of permanent magnets 52, electrical coil 54, and plurality of permanent magnets 56 may each have a greater number of poles than plurality of permanent magnets 58 and electrical coil 60.

Axial-flux motor/generator 18 is not limited to the configuration shown in FIG. 2. For example, in some embodiments, the configuration of axial-flux motor/generator 18 shown in FIG. 2 may omit plurality of permanent magnets 58. In such embodiments, plurality of permanent magnets 56 may be configured and mounted to rotor 24 in such a manner to transmit magnetic flux across axial interface 68 to electrical coil 60, in addition to transmitting magnetic flux across axial interface 66 to electrical coil 54.

Additionally, in some embodiments, axial-flux motor/generator 18 may include different numbers of rotor discs and/or different numbers of stators than shown in FIG. 2. For example, rotor 24 may include only a single rotor disc or more than two rotor discs. Additionally, axial-flux motor/generator 18 may include other stators, in addition to stator 64, disposed adjacent rotor discs of rotor 24. Similarly, rotor 26 may have more than one rotor disc, and axial-flux motor/generator 18 may include one or more stators disposed adjacent rotor discs of rotor 26.

FIG. 3 shows another embodiment of power-conversion system 27. The embodiment of power-conversion system 27 shown in FIG. 3 may be largely the same as the embodiment shown in FIG. 2. However, electrical coil 60 may be part of a stator 70, and an additional plurality of permanent magnets 72 may be mounted to rotor 26 with an axial interface 74 disposed between plurality of permanent magnets 72 and electrical coil 60. Plurality of permanent magnets 72 may have magnetic poles facing generally in the direction of axial interface 74 so that plurality of permanent magnets 72 transmits magnetic flux across axial interface 74 to electrical coil 60. Additionally, electrical coil 60 may be configured to transmit magnetic flux across axial interface 74 when supplied with electricity. Plurality of permanent magnets 58, electrical coil 60, and plurality of permanent magnets 72 may have equal numbers of poles, and each may have fewer poles than plurality of permanent magnets 52, electrical coil 54, and plurality of permanent magnets 56.

In the embodiment shown in FIG. 3, plurality of permanent magnets 58, electrical coil 60, and plurality of permanent magnets 72 may, in combination, electromagnetically couple rotor 24 and rotor 26. Magnetic flux from plurality of permanent magnets 58 may affect electrical activity in electrical coil 60, which may affect electromagnetic interaction between electrical coil 60 and plurality of permanent magnets 72.

Power-conversion system 27 of axial-flux motor/generator 18 is not limited to the configurations shown in FIGS. 2 and 3. For example, while FIGS. 2 and 3 show all permanent magnets mounted to exterior surfaces of rotors 24, 26, some or all of the permanent magnets may be inset in or completely submersed in rotors 24, 26. Additionally, power-conversion system 27 may include more or fewer sources of magnetic flux than shown in FIGS. 2 and 3. Additionally, power-conversion system 27 may include one or more electrical coils in place of plurality of permanent magnets 52, plurality of permanent magnets 56, plurality of permanent magnets 58, and/or plurality of permanent magnets 72. Similarly, power-conversion system 27 may include permanent magnets in place of plurality of electrical coil 54 and/or electrical coil 60.

Additionally, in some embodiments, axial-flux motor/generator 18 may include different numbers of rotor discs and/or different numbers of stators than shown in FIG. 3. For example, rotor 24 may include only a single rotor disc or more than two rotor discs. Additionally, axial-flux motor/generator 18 may include other stators, in addition to stator 64, disposed adjacent rotor discs of rotor 24. Similarly, rotor 26 may have more than one rotor disc, and axial-flux motor/generator 18 may include other stators, in addition to stator 70, disposed adjacent the rotor discs of rotor 26.

### INDUSTRIAL APPLICABILITY

Machine 10 and power system 12 may have application wherever power is required to perform one or more tasks. Power-system controls 20 may cause power system 12 to generate electricity with axial-flux motor/generator 18. For example, power-system controls 20 may cause mechanical power source 16 to drive rotor 24 while axial-flux motor/generator 18 generates electricity with mechanical power received from mechanical power source 16. As mechanical power source 16 rotates rotor 24 about rotation axis 28, magnetic flux flowing from plurality of permanent magnets 52 across axial interface 62 and magnetic flux flowing from plurality of permanent magnets 56 across axial interface 66 may induce electric current in electrical coil 54.

In addition to causing power system 12 to generate electricity with axial-flux motor/generator 18, power-system controls 20 may cause axial-flux motor/generator 18 to operate as an electric motor to drive rotor 26 in some circumstances. For example, when an operator of machine 10 makes an acceleration request with accelerator pedal 47, power-system controls 20 may respond by causing axial-flux motor/generator 18 to operate as an electric motor driving rotor 26, thereby driving propulsion devices 14 and propelling machine 10. In some circumstances, power-system controls 20 may cause axial-flux motor/generator 18 to operate as an electric motor to drive rotor 26 while simultaneously causing mechanical power source 16 to drive rotor 24 and axial-flux motor/generator 18 to generate electricity with rotor 24.

Power-system controls 20 may cause axial-flux motor/generator 18 to operate as an electric motor by supplying electricity to electrical coil 60 in a manner to cause electrical coil 60 to generate a rotating field of magnetic flux. In the case of the embodiment shown in FIG. 2, this rotating field of magnetic flux may interact with magnetic flux from plurality of permanent magnets 58 to transfer power between electrical coil 60 and plurality of permanent magnets 58 to drive rotor 26. In the case of the embodiment shown in FIG. 3, the rotating field of magnetic flux generated by electrical coil 60 may interact with magnetic flux from plurality of permanent magnets 72 to transfer power between electrical coil 60 and plurality of permanent magnets 72 to drive rotor 26.

Additionally, in some circumstances, power-system controls 20 may also cause axial-flux motor/generator 18 to generate electricity with mechanical power from rotor 26. For example, when machine 10 is in motion and an operator transmits a braking request with brake pedal 49, power-system controls 20 may cause axial-flux motor/generator 18 to generate electricity in electrical coil 60 with power transmitted to rotor 26 by propulsion devices 14, thereby braking machine 10. Power-system controls 20 may do so by regulating electrical activity in electrical coil 60 in such a manner that magnetic flux from plurality of permanent magnets 58 or from plurality of permanent magnets 72 induces electric current in electrical coil 60.

Furthermore, in some circumstances, power-system controls 20 may cause axial-flux motor/generator 18 to operate as an electric motor to rotate rotor 24. For example, when mechanical power source 16 is not running and an operator manipulates starter switch 51 to request starting of mechanical power source 16, power-system controls 20 may cause axial-flux motor/generator 18 to operate as an electric motor to drive rotor 24 and, thus, mechanical power source 16.

The disclosed embodiments may allow power-system controls 20 to control rotors 24, 26 completely independently, thereby utilizing axial-flux motor/generator 18 to effectively perform the roles of two axial-flux motor/generators. Because rotors 24, 26 are mechanically decoupled, power-system controls 20 may control the speed and direction of rotation of each of rotors 24, 26 independently. Power-system controls 20 may control whether axial-flux motor/generator 18 generates electricity with rotor 24 or drives rotor 24 independently of whether axial-flux motor/generator 18 generates electricity with rotor 26 or drives rotor 26. Additionally, by providing a stationary source of reaction torque for rotor 24, stator 64 may allow power-system controls 20 to control the torque on rotor 24 independently of the torque on rotor 26.

The disclosed embodiments of power system 12 may be energy efficient, space efficient, and inexpensive. The ability to control the speed and torque at rotors 24, 26 independently may enable power system 12 to supply mechanical power in an energy efficient manner across a wide range of speeds and torques. When mechanical power source 16 drives rotor 24 and axial-flux motor/generator 18 uses rotor 24 to generate electricity, power-system controls 20 may control the speed and torque at rotor 24 in a manner to generate electricity with maximum energy efficiency. Simultaneously, using the efficiently generated electricity, axial-flux motor/generator 18 may operate as an electric motor to drive rotor 26 through a wide range of speeds and torques. Using a single axial-flux motor/generator 18 to simultaneously generate electricity and drive a mechanical power load may conserve space for other components of power system 12 and machine 10. Similarly, using a single axial-flux motor/generator 18 for these purposes may help keep component costs of power system 12 low.

Additionally, configuring the sources of magnetic flux associated with rotor 26 with fewer poles than the sources of magnetic flux associated with rotor 24 may enhance the energy efficiency of power system 12 in some applications and/or circumstances. In some cases, when operating as an electric motor driving rotor 26, axial-flux motor/generator 18 may convert electricity to mechanical power most efficiently by driving rotor 26 at a relatively high speed. Configuring the sources of magnetic flux associated with rotor 26 with a relatively low number of poles may enable axial-flux motor/generator 18 to drive rotor 26 at relatively high speeds. Conversely, when generating electricity with rotor 24, axial-flux motor/generator 18 may convert mechanical power to electricity most efficiently if the sources of magnetic flux associated with rotor 24 have a relatively greater number of poles and rotor 24 rotates relatively slowly.

It will be apparent to those skilled in the art that various modifications and variations can be made in the power system and methods without departing from the scope of the disclosure. Other embodiments of the disclosed power system and methods will be apparent to those skilled in the art from consideration of the specification and practice of the power system and methods disclosed herein. It is intended that the specification and examples be considered as exemplary only, with a true scope of the disclosure being indicated by the following claims and their equivalents.

What is claimed is:

1. A power system, comprising:
an axial-flux motor/generator, including
a housing,
a first rotor supported at least partially from the housing,
a second rotor supported at least partially from the housing, the second rotor being mechanically decoupled from the first rotor;
a mechanical power source drivingly connected to the first rotor; and
power-system controls operable to
selectively cause the mechanical power source to drive the first rotor while the axial-flux motor/generator generates electricity with mechanical power the first rotor receives from the mechanical power source,
selectively cause the axial-flux motor/generator to operate as an electric motor to rotate the second rotor, and
control torque on the first rotor and torque on the second rotor independently.

2. The power system of claim 1, wherein the power-system controls are further operable to selectively cause the axial-flux motor/generator to generate electricity with mechanical power received by the second rotor.

3. The power system of claim 1, wherein:
the axial-flux motor/generator further includes
an electrical coil,
a source of magnetic flux disposed proximate the electrical coil;
one of the electrical coil and the source of magnetic flux is mounted to the first rotor and the other is disposed off of the first rotor; and
the source of magnetic flux is operable to transmit magnetic flux across an axial interface between the source of magnetic flux and the electrical coil.

4. The power system of claim 1, wherein:
the axial-flux motor/generator further includes
a first electrical coil and a first source of magnetic flux,
a second electrical coil and a second source of magnetic flux, the second source of magnetic flux having fewer poles than the source of magnetic flux;
the axial-flux motor/generator generating electricity with mechanical power the first rotor receives from the mechanical power source includes the first source of magnetic flux inducing electric current in the first electrical coil; and
selectively causing the axial-flux motor/generator to operate as an electric motor rotating the second rotor includes selectively transferring power between the second source of magnetic flux and the second electrical coil through magnetic flux.

5. The power system of claim 1, wherein:
the axial-flux motor/generator further includes a first electrical coil disposed proximate the first rotor; and
the axial-flux motor/generator further includes a first plurality of permanent magnets that are mounted to the first rotor and that transmit magnetic flux across an axial interface between the first rotor and the first electrical coil.

6. The power system of claim 7, wherein:
the axial-flux motor/generator further includes a second electrical coil; and
the axial-flux motor/generator further includes a second plurality of permanent magnets that are mounted to the second rotor and that transmit magnetic flux across an axial interface between the second rotor and the second electrical coil.

7. The power system of claim 1, wherein the first rotor and the second rotor are electromagnetically coupled.

8. A method of operating a power system, comprising:
supporting a first rotor of an axial-flux motor/generator at least partially from a housing of the axial-flux motor/generator;
supporting a second rotor of the axial-flux motor/generator at least partially from the housing, the second rotor being mechanically decoupled from the first rotor;
selectively supplying electricity to a first electrical coil of the axial-flux motor/generator in a manner to operate the axial-flux motor/generator as an electric motor driving the first rotor; and
selectively driving the second rotor with a mechanical power source while using the axial-flux motor/generator to generate electricity with mechanical power the second rotor receives from the mechanical power source.

9. The method of claim 8, wherein:
the power system is part of a mobile machine; and
selectively supplying electricity to a first electrical coil of the axial-flux motor/generator in a manner to operate the axial-flux motor/generator as an electric motor driving the first rotor includes selectively driving the first rotor and one or more propulsion devices drivingly connected to the first rotor to propel the mobile machine.

10. The method of claim 8, wherein selectively supplying electricity to a first electrical coil of the axial-flux motor/generator in a manner to operate the axial-flux motor/generator as an electric motor driving the first rotor includes selectively doing so while simultaneously driving the second rotor with the mechanical power source and using the axial-flux motor/generator to generate electricity with mechanical power the second rotor receives from the mechanical power source.

11. The method of claim 8, further including controlling torque on the first rotor and torque on the second rotor independently.

12. The method of claim 8, wherein:
using the axial-flux motor/generator to generate electricity with mechanical power the second rotor receives from the mechanical power source includes inducing electric current in a second electrical coil with magnetic flux from a proximate source; and
the magnetic flux crosses an axial interface between the second electrical coil and the proximate source.

13. The method of claim 8, wherein:
selectively supplying electricity to a first electrical coil of the axial-flux motor/generator in a manner to operate the axial-flux motor/generator as an electric motor driving the first rotor includes supplying electricity to the first electrical coil in a manner to generate magnetic flux that interacts with magnetic flux from a proximate source to drive the first rotor; and
the magnetic flux from the proximate source flows across an axial interface between the proximate source and the first electrical coil.

14. The method of claim 8, wherein:
selectively supplying electricity to a first electrical coil of the axial-flux motor/generator in a manner to operate the axial-flux motor/generator as an electric motor driving the first rotor includes supplying electricity to the first electrical coil in a manner to generate magnetic flux that interacts with magnetic flux from a first source of magnetic flux to drive the first rotor; and
using the axial-flux motor/generator to generate electricity with mechanical power the second rotor receives from the mechanical power source includes inducing electric current in a second electrical coil with magnetic flux from a second source, the second source of magnetic flux having more poles than the first source of magnetic flux.

15. A mobile machine, including:
one or more propulsion devices;
a power system, including
a mechanical power source,
an axial-flux motor/generator, including
a housing,
a first rotor supported at least partially from the housing, the first rotor being drivingly connected to the mechanical power source,
a second rotor supported at least partially from the housing, the second rotor being mechanically decoupled from the first rotor and drivingly connected to one or more of the one or more propulsion devices, and
a stator disposed adjacent at least one of the first rotor and the second rotor.

16. The mobile machine of claim 15, further including power-system controls operable to cause the mechanical power source to drive the first rotor while the axial-flux motor/generator generates electricity in the first electrical coil with power the first rotor receives from the mechanical power source.

17. The mobile machine of claim 16, wherein the power-system controls are also operable to cause the axial-flux motor/generator to operate as an electric motor to drive the second rotor and the one or more propulsion devices drivingly connected thereto, thereby propelling the mobile machine.

18. The mobile machine of claim 15, wherein:
the axial-flux motor/generator further includes
an electrical coil,
a source of magnetic flux disposed proximate the electrical coil with a first axial interface therebetween;
one of the electrical coil and the source of magnetic flux is mounted to the first rotor and the other is mounted to the stator; and
the source of magnetic flux is operable to transmit magnetic flux across the axial interface to the first electrical coil.

19. The mobile machine of claim 15, wherein:
the axial-flux motor/generator further includes
an electrical coil,
a source of magnetic flux disposed proximate the electrical coil with an axial interface disposed therebetween;
one of the electrical coil and the source of magnetic flux is mounted to the second rotor and the other is disposed off of the second rotor; and
the source of magnetic flux is operable to transmit magnetic flux across the axial interface to the electrical coil.

20. The mobile machine of claim 15, wherein:
the axial-flux motor/generator further includes
a first electrical coil and a first source of magnetic flux disposed proximate the first electrical coil, one of the first electrical coil and the first source of magnetic flux being mounted to the first rotor and the other being disposed off of the first rotor, and
a second electrical coil and a second source of magnetic flux disposed proximate the first electrical coil, one of the second electrical coil and the second source of magnetic flux being mounted to the second rotor and the other being disposed off of the second rotor, and the second source of magnetic flux having fewer poles than the first source of magnetic flux.
